(19) United States
(12) Patent Application Publication
(10) Pub. No.: US 2013/0290441 A1
(43) Pub. Date: Oct. 31, 2013

(54) SERVER LOGGING MODULE

(71) Applicant: Loren Linden Levy, Oakland, CA (US)

(72) Inventor: Loren Linden Levy, Oakland, CA (US)

(73) Assignee: MobiTV, Inc., Emeryville, CA (US)

(21) Appl. No.: 13/489,696

(22) Filed: Jun. 6, 2012

Related U.S. Application Data
(60) Provisional application No. 61/639,151, filed on Apr. 27, 2012.

(51) Int. Cl. G06F 15/16

(52) U.S. Cl. 709/206

(57) ABSTRACT

Techniques are described herein for logging messages at a server. In some embodiments, a plurality of client request messages from one or more client machines may be received at a server logging module in a server. The received client request messages may be parsed to extract one or more request headers and an request body from each received client request message. Request body characterization information may be created based on the parsed request body. Message information may be stored in a server log in accordance with a standard log format. The message information may include the one or more request headers and the request body characterization information associated with each received client request message.

### CROSS-REFERENCE TO RELATED APPLICATIONS

This application claims priority under 35 U.S.C. §119 to Provisional U.S. Patent Application No. 61/639,151 (Attorney Docket No. MOBIP096P) by Loren Linden Levy, titled “Server Logging Module,” filed Apr. 27, 2012, which is incorporated herein by reference in its entirety and for all purposes.

### TECHNICAL FIELD

The present disclosure relates to a server logging module.

### DESCRIPTION OF RELATED ART

A variety of modules can be used to log requests made to a server such as a web server. Logs may be written in particular formats into a file or to external applications. Conditional logging may be used so that only certain types and classes of data are maintained. Server logs may maintain source and destination address information for requests, size of responses, time taken to server the request, file names, protocol information, process identifiers, etc.

Logs may be used to manage server resources, maintain security, track user activity, etc. However, many conventional logging modules are limited. Consequently, techniques and mechanisms are provided to enhance logging use and efficiency.

### BRIEF DESCRIPTION OF THE DRAWINGS

The disclosure may best be understood by reference to the following description taken in conjunction with the accompanying drawings, which illustrate particular embodiments.

FIG. 1 illustrates one example of a media delivery system.

FIG. 2 illustrates another example of a media delivery system.

FIG. 3 illustrates examples of encoding streams.

FIG. 4 illustrates one example of an exchange used with a media delivery system.

FIG. 5 illustrates one technique for generating a media segment.

FIG. 6 illustrates one example of a system.

FIG. 7 illustrates one technique for configuring a server logging module.

FIG. 8 illustrates one technique for performing server logging.

FIG. 9 illustrates one technique for replaying a server log.

### DESCRIPTION OF EXAMPLE EMBODIMENTS

Reference will now be made in detail to some specific examples of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims.

For example, the techniques of the present invention will be described in the context of fragments, particular servers and encoding mechanisms. However, it should be noted that the techniques of the present invention apply to a wide variety of different fragments, segments, servers and encoding mechanisms. In the following description, numerous specific details are set forth in order to provide a thorough understanding of the present invention. Particular example embodiments of the present invention may be implemented without some or all of these specific details. In other instances, well known process operations have not been described in detail in order not to unnecessarily obscure the present invention.

Various techniques and mechanisms of the present invention will sometimes be described in singular form for clarity. However, it should be noted that some embodiments include multiple iterations of a technique or multiple instantiations of a mechanism unless noted otherwise. For example, a system uses a processor in a variety of contexts. However, it will be appreciated that a system can use multiple processors while remaining within the scope of the present invention unless otherwise noted. Furthermore, the techniques and mechanisms of the present invention will sometimes describe a connection between two entities. It should be noted that a connection between two entities does not necessarily mean a direct, unimpeded connection, as a variety of other entities may reside between the two entities. For example, a processor may be connected to memory, but it will be appreciated that a variety of bridges and controllers may reside between the processor and memory. Consequently, a connection does not necessarily mean a direct, unimpeded connection unless otherwise noted.

Overview

According to various embodiments, a server logging module may be used to provide always-on full client request recording that can be used to monitor production traffic for validation, debugging, testing, and/or performance evaluation at little or no cost in server performance. The server logging module may mimic a standard access log but may also record some or all headers and bodies sent from a client. The server logging module may be constructed as part of the server's core code base and/or may use native server application program interfaces (APIs). The module may be configured to be binary safe and may be limited in size, which may help to prevent disk operating system type attacks.

### Example Embodiments

According to various embodiments, a variety of server logging modules are available. However, many available logging modules have significant drawbacks. For example, logging modules that allow recording of the entirety of client requests are not formatted in the same manner as standard web access logs and are therefore difficult to parse. Furthermore, these logging modules tend to only be active when the verbosity level or state of the server is changed to debug, often because the logging modules impose significant overhead. Also, many available logging modules open the server to various attacks, such as denial of service (DOS) attacks or code injection attacks, due to the additional processing and logging of headers and bodies.

According to various embodiments, it is recognized that in order to debug client server interactions and test production traffic in quality assurance (QA) environments the entire client request to a server should be logged. In other words, the logging mechanism may be configured to record all headers and bodies sent from the client. In some embodiments, this log should be similar to a standard access log, and the logging mechanism may not incur any significant overhead. Accordingly, the logging mechanism may be constructed as part of the web servers core code base and/or as a module using the web server module native application program interface (API). In addition, the logging mechanism may be configured to be binary safe. For instance, client request bodies could include DIM keys and other sensitive information. The logging mechanism may also be limited in size, which may help to prevent DOS-type attacks.

According to various embodiments, a server logging module allows for a variety of new entries to be recorded in a common log format. In particular embodiments, these new entries may include any or all of the following: some or all of the input headers separated by a marker character; the entire input body; some or all of the response (server supplied) headers separated by a marker character; the response (server supplied) body. The module may be configured to be binary safe (for headers and body) and may allow the user to specify the separation characters as well as the body size limits (for ease of parsing and prevention of DOS attacks respectively). The module may provide a log that follows the same or similar format as the default web server access log (modulo the new fields). Which may allow it to be parsed by one of the many existing tools that work with common log format access logs. The parsed production data can then be replayed against a chosen environment at the users' discretion. The module may constructed in the native code base of the web server, which in some embodiments results in an overhead in CPU time and memory usage of less than 1% (e.g., with binary request bodies the size of the body limit) beyond that of the standalone web server.

According to various embodiments, the log may be used to debug client-server interactions in a testing environment and/or to debug/detect a DOS style attacks. Alternately, or additionally, the log may be used as an always-on full client request recording that can be used to record production traffic. This traffic can then be replayed against servers in a QA, near production, performance testing, and/or debugging lab.

According to various embodiments, this implementation may allow a complete record of production traffic for validation, debugging, testing, and/or performance evaluation at little or no cost in server performance.

According to various embodiments, the standard format of the output log may allow users to parse the data with one of the many available common log format parsing tools.

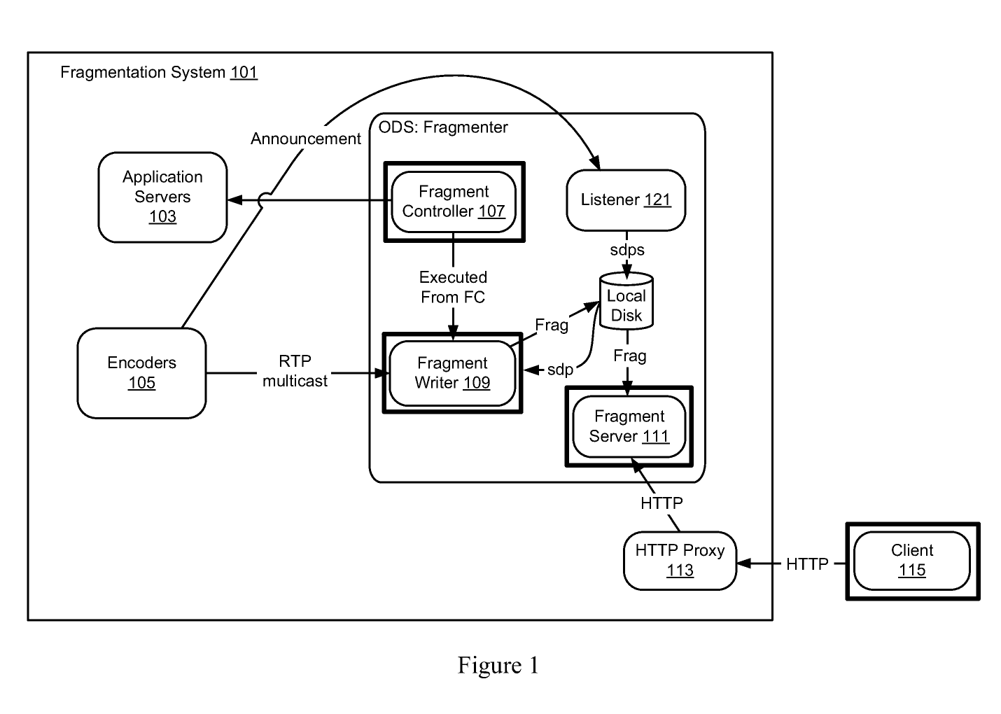

FIG. 1 is a diagrammatic representation illustrating one example of a system 101 associated with a content server that can use server logging techniques and mechanisms. Encoders 105 receive media data from satellite, content libraries, and other content sources and sends RTP multicast data to fragment writer 109. The encoders 105 also send session announcement protocol (SAP) announcements to SAP listener 121. According to various embodiments, the fragment writer 109 creates fragments for live streaming, and writes files to disk for recording. The fragment writer 109 receives RIP multicast streams from the encoders 105 and parses the streams to repackage the audio/video data as part of fragmented MPEG-4 files. When a new program starts, the fragment writer 109 creates a new MPEG-4 file on fragment storage and appends fragments. In particular embodiments, the fragment writer 109 supports live and/or DVR configurations.

The fragment server 111 provides the caching layer with fragments for clients. The design philosophy behind the client/server application programming interface (API) minimizes round trips and reduces complexity as much as possible when it comes to delivery of the media data to the client 115. The fragment server 111 provides live streams and/or DVR configurations.

The fragment controller 107 is connected to application servers 103 and controls the fragmentation of live channel streams. The fragmentation controller 107 optionally integrates guide data to drive the recordings for a global/network DVR. In particular embodiments, the fragment controller 107 embeds logic around the recording to simplify the fragment writer 109 component. According to various embodiments, the fragment controller 107 will run on the same host as the fragment writer 109. In particular embodiments, the fragment controller 107 instantiates instances of the fragment writer 109 and manages high availability.

According to various embodiments, the client 115 uses a media component that requests fragmented MPEG-4 files, allows trick-play, and manages bandwidth adaptation. The client communicates with the application services associated with HTTP proxy 113 to get guides and present the user with the recorded content available.

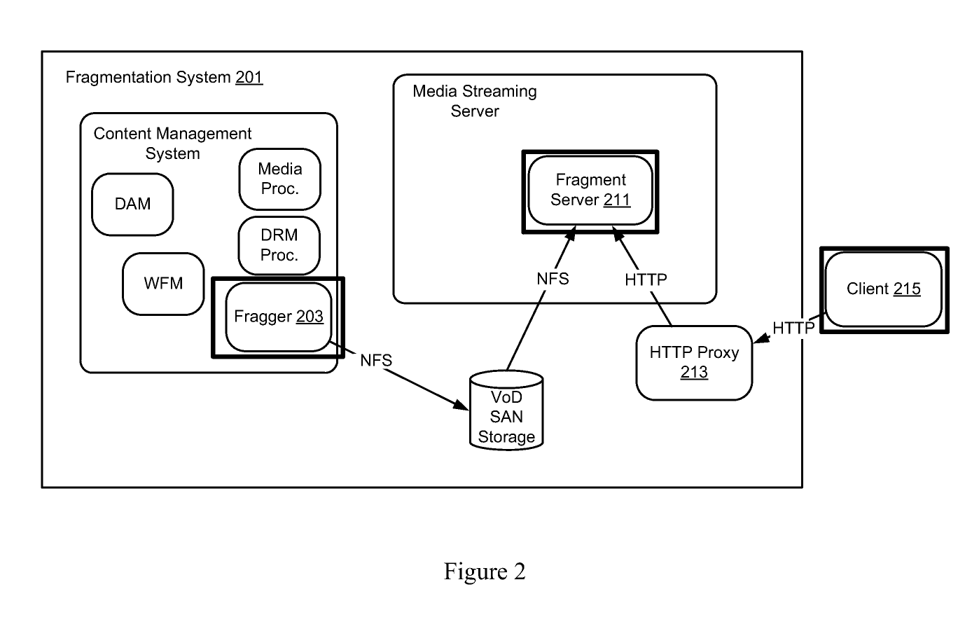

FIG. 2 illustrates one example of a fragmentation system 201 that can be used for video-on-demand (VoD) content. Fragger 203 takes an encoded video clip source. However, the commercial encoder does not create an output file with minimal object oriented framework (MOOF) headers and instead embeds all content headers in the movie file (MOOV). The fragger reads the input file and creates an alternate output that has been fragmented with MOOF headers, and extended with custom headers that optimize the experience and act as hints to servers.

The fragment server 211 provides the caching layer with fragments for clients. The design philosophy behind the client/server API minimizes round trips and reduces complexity as much as possible when it comes to delivery of the media data to the client 215. The fragment server 211 provides VoD content.

According to various embodiments, the client 215 uses a media component that requests fragmented MPEG-4 files, allows trick-play, and manages bandwidth adaptation. The client communicates with the application services associated with HTTP proxy 213 to get guides and present the user with the recorded content available.

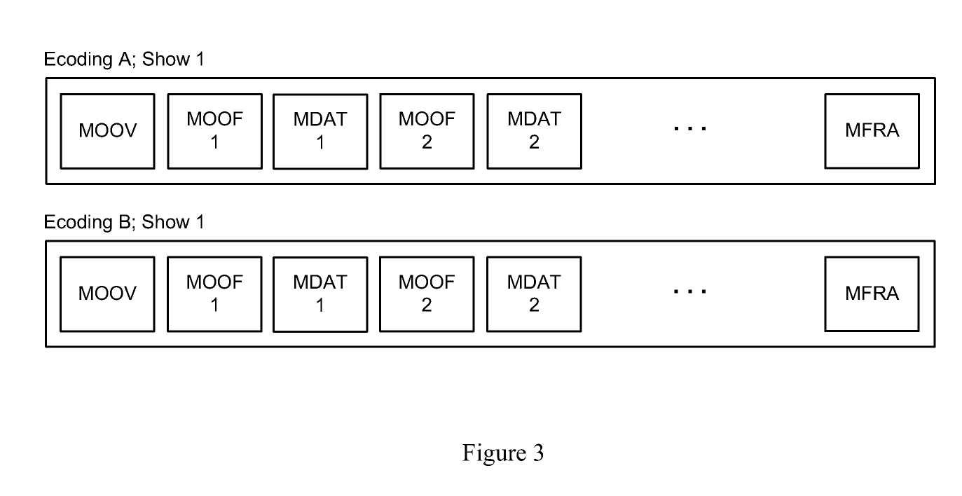

FIG. 3 illustrates examples of files stored by the fragment writer. According to various embodiments, the fragment writer is a component in the overall fragmenter. It is a binary that uses command line arguments to record a particular program based on either NTP time from the encoded stream or wallclock time. In particular embodiments, this is configurable as part of the arguments and depends on the input stream. When the fragment writer completes recording a program, it exits. For live streams, programs are artificially created to be short time intervals e.g. 5-15 minutes in length.

According to various embodiments, the fragment writer command line arguments are the SDP file of the channel to record, the start time, end time, name of the current and next output files. The fragment writer listens to RTP traffic from the live video encoders and rewrites the media data to disk as fragmented MPEG-4. According to various embodiments, media data is written as fragmented MPEG-4 as defined in MPEG-4 part 12 (ISO/IEC 14496-12). Each broadcast show is written to disk as a separate file indicated by the show ID (derived from EPG). Clients include the show ID as part of the channel name when requesting to view a prerecorded show. The fragment writer consumes each of the different encodings and stores them as a different MPEG-4 fragment.

In particular embodiments, the fragment writer writes the RTP data for a particular encoding and the show ID field to a single file. Inside that file, there is metadata information that describes the entire file (MOOV blocks). Atoms are stored as groups of MOOF/MDAT pairs to allow a show to be saved as a single file. At the end of the file there is random access information that can be used to enable a client to perform bandwidth adaptation and trick play functionality.

According to various embodiments, the fragment writer includes an option which encrypts fragments to ensure stream security during the recording process. The fragment writer will request an encoding key from the license manager. The keys used are similar to that done for DRM. The encoding format is slightly different where MOOF is encoded. The encryption occurs once so that it does not create prohibitive costs during delivery to clients.

The fragment server responds to HTTP requests for content. According to various embodiments, it provides APIs that can be used by clients to get necessary headers required to decode the video and seek any desired time frame within the fragment and APIs to watch channels live. Effectively, live channels are served from the most recently written fragments for the show on that channel. The fragment server returns the media header (necessary for initializing decoders), particular fragments, and the random access block to clients. According to various embodiments, the APIs supported allow for optimization where the metadata header information is returned to the client along with the first fragment. The fragment writer creates a series of fragments within the file. When a client requests a stream, it makes requests for each of these fragments and the fragment server reads the portion of the file pertaining to that fragment and returns it to the client.

According to various embodiments, the fragment server uses a REST API that is cache-friendly so that most requests made to the fragment server can be cached. The fragment server uses cache control headers and ETag headers to provide the proper hints to caches. This API also provides the ability to understand where a particular user stopped playing and to start play from that point (providing the capacity for pause on one device and resume on another). In particular embodiments, client requests for fragments follow the following format: http://{HOSTNAME}/frag/{CHANNEL}/{BITRATE}/[{ID}/]{COMMAND}[/{ARG}] e.g. http://frag.hosttv.com/frag/1/H8QVGAH264/1270059632.mp4/fragment/42. According to various embodiments, the channel name will be the same as the backend-channel name that is used as the channel portion of the SDP file. VoD uses a channel name of “vod”. The BITRATE should follow the BITRATE/RESOLUTION identifier scheme used for RTP streams. The ID is dynamically assigned. For live streams, this may be the UNIX timestamp; for DVR this will be a unique ID for the show; for VoD this will be the asset ID. The ID is optional and not included, in LIVE command requests. The command and argument are used to indicate the exact command desired and any arguments. For example, to request chunk 42, this portion would be “fragment42”.

The URL format makes the requests content delivery network (CDN) friendly because the fragments will never change after this point so two separate clients watching the same stream can be serviced using a cache. In particular, the head end architecture leverages this to avoid too many dynamic requests arriving at the Fragment Server by using an HTTP proxy at the head end to cache requests.

According to various embodiments, the fragment controller is a daemon that runs on the fragmenter and manages the fragment writer processes, A configured filter that is executed by the fragment controller can be used to generate the list of broadcasts to be recorded. This filter integrates with external components such as a guide server to determine which shows to record and, which broadcast ID to use.

According to various embodiments, the client includes an application logic component and a media rendering component. The application logic component presents the user interface (UI) for the user, communicates to the front-end server to get shows that are available for the user, and authenticates the content. As part of this process, the server returns URLs to media assets that are passed to the media rendering component.

In particular embodiments, the client relies on the fact that each fragment in a fragmented MP4 file has a sequence number. Using this knowledge and a well-defined URL structure for communicating with the server, the client requests fragments individually as if it was reading separate files front the server simply by requesting URLs for files associated with increasing sequence numbers. In some embodiments, the client can request files corresponding to higher or lower bit rate streams depending on device and network resources.

Since each file contains the information needed to create the URL for the next file, no special playlist files are needed, and all actions (startup, channel change, seeking) can be performed with a single HTTP request. After each fragment is downloaded, the client assesses, among other things, the size of the fragment and the time needed to download it in order to determine if downshifting is needed or if there is enough bandwidth available to request a higher bit rate.

Because each request to the server looks like a request to a separate file, the response to requests can be cached in any HTTP Proxy, or be distributed over any HTTP based content delivery network CDN.

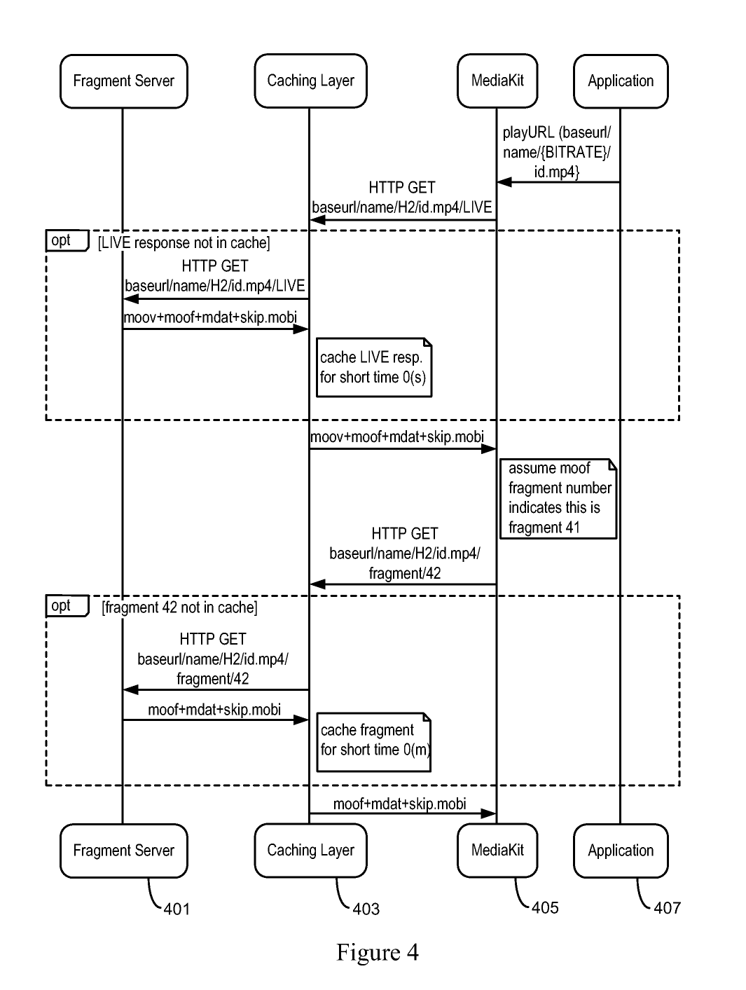

FIG. 4 illustrates an interaction for a client receiving a media stream such as a live stream. The client starts playback when fragment 41 plays out from the server. The client uses the fragment number so that it can request the appropriate subsequent file fragment. An application such as a player application 407 sends a request to mediakit 405. The request may include a base address and bit rate. The mediakit 405 sends an HTTP get request to caching layer 403. According to various embodiments, the live response is not in cache, and the caching layer 403 forwards the HTTP get request to a fragment server 401. The fragment server 401 performs processing and sends the appropriate fragment to the caching layer 403 which forwards to the data to mediakit 405.

The fragment may be cached for a short period of time at caching layer 403. The mediakit 405 identifies the fragment number and determines whether resources are sufficient to play the fragment. In some examples, resources such as processing or bandwidth resources are insufficient. The fragment may not have been received quickly enough, or the device may be having trouble decoding the fragment with sufficient speed. Consequently, the mediakit 405 may request a next fragment having a different data rate. In some instances, the mediakit 405 may request a next fragment having a higher data rate. According to various embodiments, the fragment server 401 maintains fragments for different quality of service streams with timing synchronization information to allow for timing accurate playback.

The mediakit 405 requests a next fragment using information from the received fragment. According to various embodiments, the next fragment for the media stream may be maintained on a different server, may have a different bit rate, or may require different authorization. Caching layer 403 determines that the next fragment is not in cache and forwards the request to fragment server 401. The fragment server 401 sends the fragment to caching layer 403 and the fragment is cached for a short period of time. The fragment is then sent to mediakit 405.

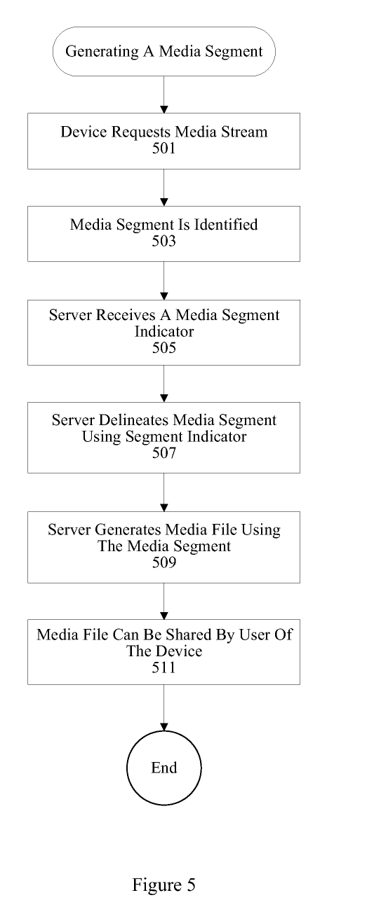

FIG. 5 illustrates a particular example of a technique for generating a media segment. According to various embodiments, a media stream is requested by a device at 501. The media stream may be a live stream, media clip, media file, etc. The request for the media stream may be an HTTP GET request with a baseurl, bit rate, and file name. At 503, the media segment is identified. According to various embodiments, the media segment may be a 35 second sequence from an hour long live media stream. The media segment may be identified using time indicators such as a start time and end time indicator. Alternatively, certain sequences may include tags such as fight scene, car chase, love scene, monologue, etc., that the user may select in order to identify a media segment. In still other examples, the media stream may include markers that the user can select. At 505, a server receives a media segment indicator such as one or more time indicators, tags, or markers. In particular embodiments, the server is a snapshot server, content server, and/or fragment server. According to various embodiments, the server delineates the media segment maintained in cache using the segment indicator at 507. The media stream may only be available in a channel buffer. At 509, the server generates a media file using the media segment maintained in cache. The media file can then be shared by a user of the device at 511, in some examples, the media file itself is shared while in other examples, a link to the media file is shared.

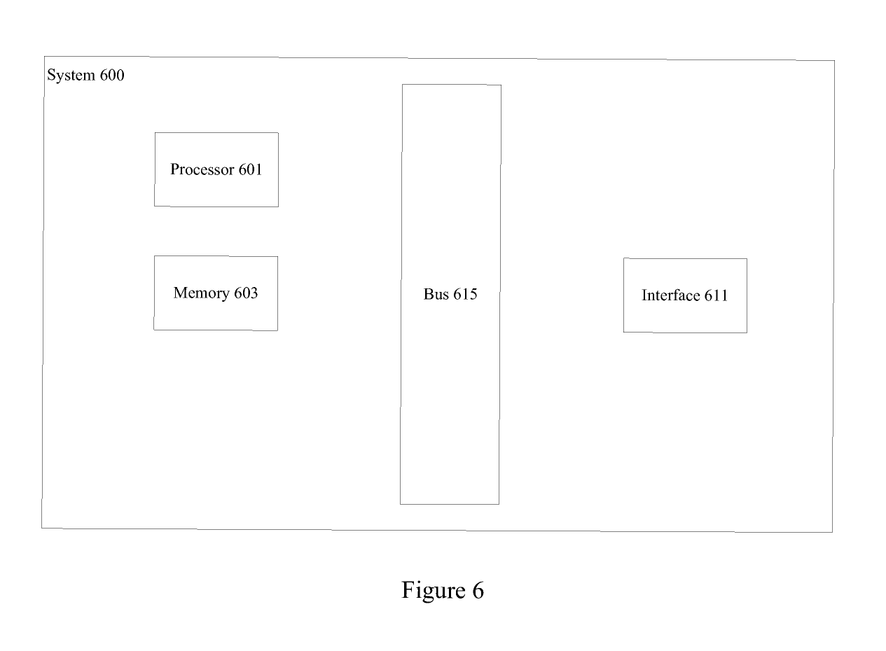

FIG. 6 illustrates one example of a server. According to particular embodiments, a system 600 suitable for implementing particular embodiments of the present invention includes a processor 601, a memory 603, an interface 611, and a bus 615 (e.g., a PCI bus or other interconnection fabric) and operates as a streaming server. When acting under the control of appropriate software or firmware, the processor 601 is responsible for modifying and transmitting live media data to a client. Various specially configured devices can also be used in place of a processor 601 or in addition to processor 601. The interface 611 is typically configured to send and receive data packets or data segments over a network.

Particular examples of interfaces supported include Ethernet interfaces, frame relay interfaces, cable interfaces, DSL interfaces, token ring interfaces, and the like. In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control communications-intensive tasks such as packet switching, media control and management.

According to various embodiments, the system 600 is a server that also includes a transceiver, streaming buffers, and a program guide database. The server may also be associated with subscription management, logging and report generation, and monitoring capabilities. In particular embodiments, the server can be associated with functionality for allowing operation with mobile devices such as cellular phones operating in a particular cellular network and providing subscription management capabilities. According to various embodiments, an authentication module verifies the identity of devices including mobile devices. A logging and report generation module tracks mobile device requests and associated responses. A monitor system allows an administrator to view usage patterns and system availability. According to various embodiments, the server handles requests and responses for media content related transactions while a separate streaming server provides the actual media streams.

Although a particular server is described, it should be recognized that a variety of alternative configurations are possible. For example, some modules such as a report and logging module and a monitor may not be needed on every server. Alternatively, the modules may be implemented on another device connected to the server. In another example, the server may not include an interface to an abstract buy engine and may in fact include the abstract buy engine itself, A variety of configurations are possible.

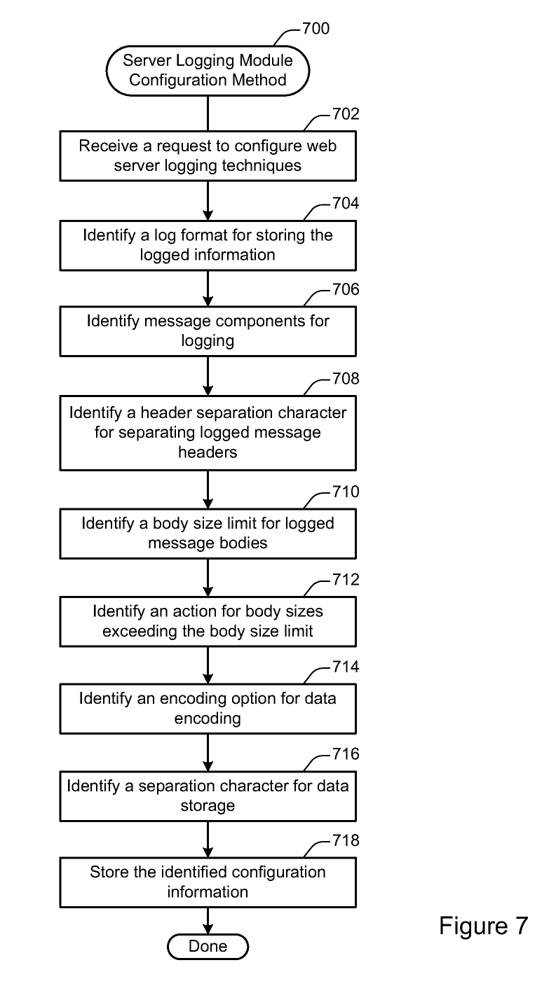

FIGS. 7-9 illustrate examples of techniques related to server logging. Examples of servers may include, but are not limited to, computers running a web server such as the Apache HTTP Server, Tux, HS, nginx, GWS, Resin, lightpd, or Sun Java System Web Server, computers running an application server such as a Java or .NET server, or computers running any other type of server software.

Some of the techniques described in FIGS. 7-9 are described as being performed at least in part by a server logging module. According to various embodiments, a server logging module may be a portion of computer programming code configured to communicate with a server via an API, such as a native API associated with the server. Alternately, a server logging module may be a portion of computer programming code integrated with the core computer code used to provide the web server.

Some of the techniques described in FIGS. 7-9 refer to request messages and response messages. According to various embodiments, request messages include messages transmitted from a client machine to a server, while response messages include messages transmitted from a server to a client machine. However, these categories are employed for explanatory purposes, and the server logging module may be used to log information related to a variety of messages. Further, response and request messages may in some instances be simulated or may not actually be transmitted to a client machine or another location in communication with the server via a network. In some embodiments, messages may be HTTP messages transmitted or received at a web server. Alternately, or additionally, messages of different types may be logged, such as messages transmitted or received at an application server.

Some of the techniques described in FIG. 7-9 refer to parsing or analyzing messages. According to various embodiments, messages or message data may be parsed in an XML format. Alternately, or additionally, other computer-readable and/or machine-readable data formats may be used.

FIG. 7 illustrates one example of a server logging module configuration method 700. According to various embodiments, the server logging module configuration method 700 may be used to identify and store configuration information for configuring a server module that logs communications received by the server.

According to various embodiments, the configuration information identified in various operations shown in FIG. 7 may be identified in various ways. For example, some or all of the configuration information may be identified based on user input. As another example, some or all of the configuration information may be identified automatically, such as by analyzing an existing server log or by parsing a preexisting configuration file. As yet another example, some or all of the configuration information may be identified based on default values.

At 702, a request to configure web server logging techniques is received. According to various embodiments, the request may be received from a user. Alternately, or additionally, the request may be received as part of an automatic process, such as an installation and configuration process.

At 704, a log format for storing the information logged by the server logging module is identified. According to various embodiments, various types of log formats may be employed. In a first example, the server logging module may use the Common Log Format, the Extended Log Format, or any other type of server log format. In a second example, the server logging module may use a proprietary log format or a non-proprietary log format. In a third example, the server logging module may use a logging format that has been promulgated as a standard. In a fourth example, the server logging module may use a logging format that is the same as the format employed by the server itself under normal use. In a fifth example, the server logging module may use any logging format that can be replayed by commonly used server log parsing tools.

According to various embodiments, the log format identified at operation 704 may be the same log format used by other logging operations performed at the server. In this way, the additional information captured by the server logging module configured in FIG. 7 may be stored in a manner consistent with other information logged by the server. Alternately, a different log format may be used.

At 706, message components for logging are identified. According to various embodiments, various types of message components may be logged. For example, the message headers and/or message bodies of request messages received at the server from a client machine may be logged. As another example, the message headers and/or message bodies of response messages generated at the server or elsewhere in response to the received request message may be logged.

At 708, a header separation character for separating logged message headers is identified. According to various embodiments, the header separation character may be any character or combination of characters for storing in a server log. The header separation characters that may be used may include, but are not limited to, ASCII characters and Unicode characters. In particular embodiments, the pipe symbol (“|”) may be used as the header separation character. The header separation character may be used to indicate the termination of one part of a log entry and/or the beginning of another part of a log entry. For instance, the header separation character may be placed in between message headers.

According to various embodiments, more than one header separation character may be identified at 708. For example, one or more header separation characters may be used for separating request message headers, while a different one or more header separation characters may be used to separate response message headers. Further, the header separation character may be used for other purposes, such as to separate message headers from the message body.

At 710, a body size limit for logged message bodies is identified. A message received at the server may have a message body that may include various types of data. In many instances, the message body is relatively small. For instance, the message body may be a few kilobytes in size. However, in some instances, the message body may be relatively large. For example, the message body may be several megabytes.

According to various embodiments, the body size limit identified at 710 may be used to restrict the amount of data associated with a message body that may be stored in the log. As discussed herein, restricting the size of lame message bodies in this way may help protect against attacks against the server and may reduce the amount of disk space employed in logging. In particular embodiments, the body size limit may be set to any value between zero kilobytes and several megabytes. For example, the body size limit may be set to 30 kilobytes.

According to various embodiments, imposing a body size limit may restrict the amount of server resources time used in parsing, analyzing, encoding, storing, and otherwise processing message bodies. With conventional forensic logging software, a server may be overwhelmed by a series of messages sent for legitimate purposes or as part of a DOS attack. For example, if the server records the entire message body of each message, then a series of large messages may require a large amount of CPU time or memory to process and/or a large amount of disk usage to write the bodies to disk. By imposing a body size limit, such problems may be eliminated or reduced.

According to various embodiments, the body size limit may be determined based on the maximum or average expected body size for a particular computing environment. For example, it may be determined that in a particular client-server environment, messages having a size over 30 kb are not expected. Accordingly, the body size limit may be set at 30 kb.

At 712, an action for body sizes that exceed the body size limit is identified. The action may specify, for example, how to log a message body when the message body size exceeds the limit identified at operation 710. According to various embodiments, the action may include recording the size of the message body. Alternately, or additionally, the action may include recording a truncated portion of the message body, such as the first portion up to the body size limit identified at operation 710.

At 714, an encoding option for data encoding is identified. According to various embodiments, the encoding option may specify one or more techniques for encoding data included in a received message. For example, the message body may include binary data. Then, before the message body is stored in the server log, the message body may be encoded in accordance with the encoding format. Different types of encoding options may be used, which may include, but are not limited to: hexadecimal encoding and base 64 encoding. In some embodiments, encoding may include cryptographic transformation.

According to various embodiments, encoding at least a portion of the message before storing the message in the server log may help prevent malicious attacks against the server, such as code injection attacks. In a code injection attack, the attacker sends a message that includes binary data containing computer software code. Then, when software at the server reads the binary data included in the message, the server software may inadvertently execute the injected code. By encoding the data in a different format, the data stored in the log may be rendered harmless to the server, or “binary safe”, since any code included in the data will be transformed and thus rendered unexecutable.

At 716, a separation character for data storage is identified. According to various embodiments, the separation character identified at 716 may be used to delineate a portion of data that has been encoded as described with respect to operation 714. For example, the separation character may be “#hex”. Then, a portion of encoded data “string” may be stored in the server log as “#hex string #hex”. In this way, the encoded data may be decoded when the server log is replayed or read. As discussed with respect to operation 708, the data storage separation character may include various types and combinations of actual characters.

At 718, the configuration information identified in Method 7 is stored. According to various embodiments, the configuration information may be stored in a configuration file associated with the server logging module, in a configuration file associated with the server itself, in a database, or in any other storage location.

According to various embodiments, not all of the operations shown in FIG. 7 need be performed. For example, some configuration options may not be provided. As another example, some configuration options may be set based on default values.

According to various embodiments, a server logging module configuration method may include operations not shown in FIG. 7. For example, the server logging module may have other options or settings not discussed with respect to FIG. 7.

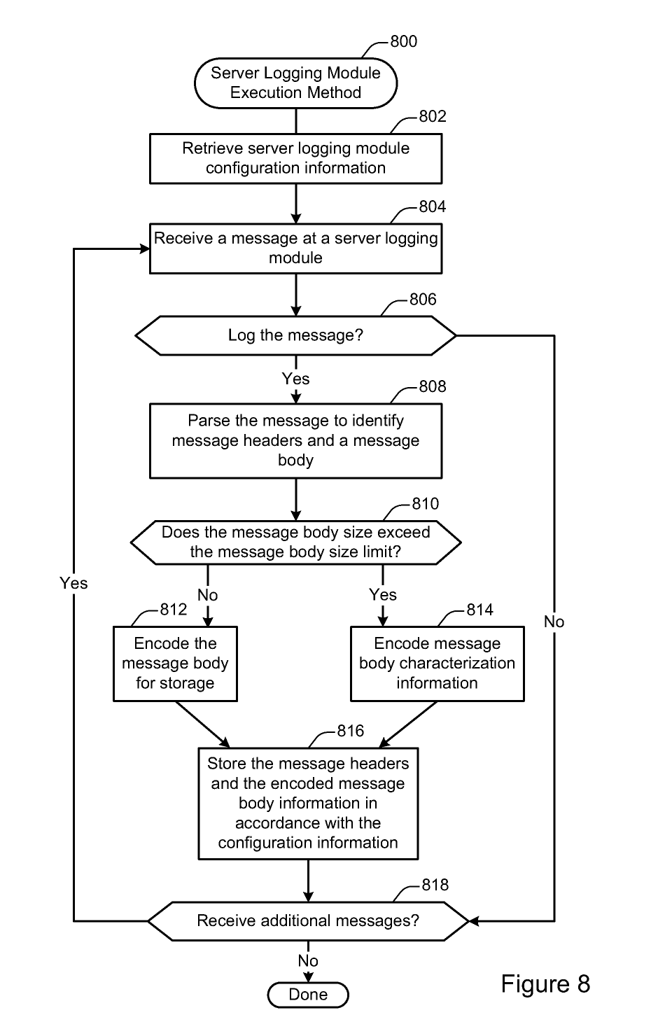

FIG. 8 illustrates one example of a server logging module execution method 800. According to various embodiments, the server logging module execution method 800 may be used to stored information regarding messages received at the server. The information may be stored in a server log in a standard log format so that it can later be replayed, read, or otherwise analyzed.

At 802, server logging module configuration information is retrieved. According to various embodiments, the retrieved configuration information may be the information identified and stored as described with respect to FIG. 7. Alternately, or additionally, other configuration information may be retrieved, such as default configuration information or other configuration information associated with the server itself.

At 804, a message is received at the server logging module. According to various embodiments, the message may be received from a client machine or from some other source. The message may be any type of message capable of being received and handled by the server. The message may be analyzed and/or processed by the server in various ways. For example, various information relating to the message may be logged by the server itself or by the server logging module. As another example, the server may generate or pass along a response message created in response to the request message. The response message may itself be logged and may be transmitted to the source of the request message or to another destination.

At 806, a determination is made as to whether to log the message. According to various embodiments, as described with respect to operation 706 shown in FIG. 7, various types of messages may be logged. For example, request messages may be logged while response messages are not logged. As another example, response messages may be logged while request messages are not logged. As yet another example, both response and request messages may be logged. The determination made at 806 may be made at least in part by comparing a message type or characteristic associated with the received message with a type or characteristic of messages indicated in the configuration message as a message to log or not to log.

At 808, the message is parsed to identify one or more message headers and a message body. According, to various embodiments, a message may contain various types and numbers of headers. For example, an HTTP message may include one or more of a large set of standard headers and/or one or more non-standard headers. A message header may include, for example, a name-value pair that characterizes the communication or the message between the client and the server. The message body may include data that serves as the message payload. That is, the message body may server as the data, while the message headers may serve as the meta-data.

According to various embodiments, the message parsing may be performed based on standard parsing operations performed by the server itself. Alternately, or additionally, the server logging module may be configured to perform some amount of message parsing.

According to various embodiments, all headers may be logged. In many web servers, logging software must identify headers by name in order to retrieve and log them. However, in some cases the server may not know which headers to expect in a particular message. Further, some messages may include malformed, non-standard, or otherwise unknown headers. Accordingly, the server logging module may be configured to log every header included in the message.

At 810, a determination is made as to whether the message body size exceeds the body size limit. According to various embodiments, the message body size limit may be determined based on the server logging module configuration information retrieved at operation 802. Then, the determination as to whether the message body size exceeds the message body limit may be made by some comparison technique, such as by comparing the string size of the message body with the retrieved message body size limit.

At 812, the message body is encoded for storage. According to various embodiments, the message body may be encoded using various encoding techniques, as described, with respect to operation 714 shown in FIG. 7. The encoding technique to employ may be determined based on the configuration information retrieved at operation 802. As described with respect to FIG. 7, encoding the message body may help prevent attacks against the server.

At 814, when it is determined that the message body size exceeds the message body size limit message body characterization information is encoded. According to various embodiments, the characterization information may include various types of information related to the message body. For example, the characterization information may include the size of the message body. As another example, the characterization information may include a portion of the message body, such as the first portion of the message body up to the message body size limit. As yet another example, the characterization information may include a hash value calculated based on the message body.

At 816, the message headers and the encoded, message body information is stored in accordance with the configuration information. According to various embodiments, the information stored at operation 816 may be stored in a server log. The information may be stored in a manner similar to other logging performed by the server or the server logging module. The server log may be created, in accordance with a standard log format so that it may be more easily read, replayed, and otherwise analyzed. As discussed with respect to operation 708 shown in FIG. 7, the message headers may be separated in the log by a header separation character. Similarly, as discussed with respect to operation 716, encoded data may be demarcated by a data storage separation character.

At 818, a determination is made as to whether to receive additional messages. According to various embodiments, messages will continue to be logged as long as the server is active. However, additional messages the logging of messages may stop in various circumstances, such as when the server logging module or the server itself shuts down.

According to various embodiments, not all of the operations shown in FIG. 8 need be performed. As described with respect to FIG. 7, the server logging module may support logging only certain parts of a received message. For example, message headers may be logged while message bodies are not logged. As another example, message bodies may be logged while message headers are not logged.

According to various embodiments, a server logging module execution method may include operations not shown in FIG. 8. For example, the server logging module may handle different types of message headers differently. In this case, the server logging module execution method may include operations for identifying, analyzing, and processing various types of message headers.

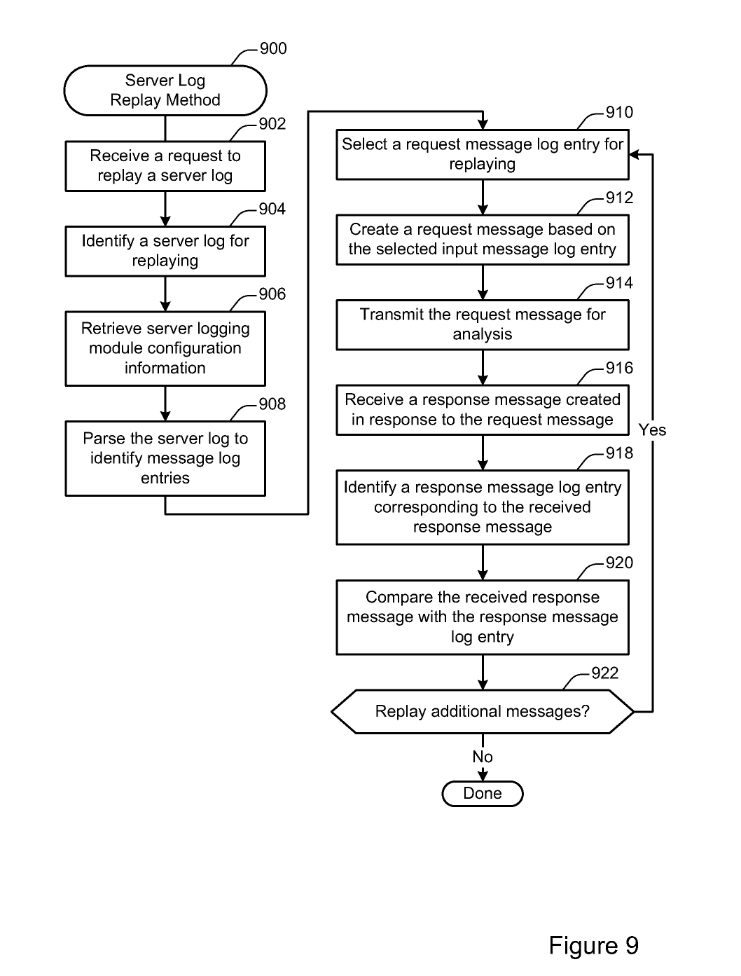

FIG. 9 illustrates one example of a server log replay method 900. According to various embodiments, the server log replay method 900 may be used to create simulated messages based on a server log created as described with respect to method 800 shown in FIG. 8. Alternately, or additionally, the server log replay method may be used to compare messages generated by a server with those stored in a server log created as described with respect to method 800. The server log replay method 900 may be used for a variety of purposes.

In some embodiments, the replay method 900 may be used to identify or isolate computer software bugs that are discovered in a server already in use. By logging the message headers and message bodies as discussed herein, the message traffic that led to the software bug under investigation may be recreated. That is, a server with similar software may be set up in a “debug mode” that facilitates greater monitoring than the server already in use. Then, message traffic may be recreated based on the server logs. In this way, the software bug may be recreated and analyzed in a laboratory environment.

In some embodiments, the replay method. 900 may be used to test a server against simulated traffic that matches actual traffic. Computer program software such as server software is often tested against artificially created “test cases.” However, such test cases often fail to capture the full range of input that may be received when the computer program is subjected to actual user input. In accordance with techniques described, herein, a server may be tested, against messages created based on actual traffic. Such a test may be run for any length of time, ranging from a single message to a few weeks or more of messages. By testing, a server against actual traffic, the test environment may be made to more closely approximate the production environment.

In some embodiments, the replay method 900 may be used to prospectively analyze the performance of a server prior to deployment. For example, a server administrator may believe that a single server is able to do the work of two servers currently in use. To test this hypothesis without risking a service disruption, the administrator may log messages handled by two servers as described with respect to FIG. 8. Then, the administrator may replay the messages against one server as described with respect to FIG. 9.

At 902, a request to replay a server log is received. According to various embodiments, the request may be received at a server logging module configured to reverse the logging processing, creating simulated messages based on logged server traffic. Alternately, or additionally, the request may be received at a server or other computer software program configured to analyze a server log and create simulated messages based on the server log.

At 904, a server log for replaying is identified. According to various embodiments, the server log may be identified based on user input. For example, a server administrator may select a server log file. Alternately, or additionally, the server log may be identified by an automatic process.

At 906, the server logging module configuration information is retrieved. According to various embodiments, the retrieval of the server logging module configuration information at operation 906 may be significantly similar to operation 802 discussed with respect to FIG. 8. The configuration information may be needed in order to decode the server log. For example, the configuration information may specify the separation characters and, encoding techniques used to create the log.

In particular embodiments, the configuration information for the server logging module may be subsumed by the configuration information for the server itself. That is, the server logging module may use the same separation characters or encoding techniques used by the server. In this case, the server logging module configuration information may be determined based on the server configuration information.

At 908, the server log is parsed to identify message log entries. According to various embodiments, the server log may be parsed in accordance with various types of parsing techniques. For example, a commercial or open source tool for parsing server logs having a standard server log format may be employed. Parsing the server log may involve retrieving the logged information from one or more log files, separating the parsed information into individual messages, and/or separating the messages into individual message components.

At 910, a request message log entry is selected. According to various embodiments, the request message log entry may represent a single request message received at the server from a client machine. The request message log entry may be selected based on a designated ordering, based on a message characteristic or type, or based on any other criteria. For example, the request message log entries may be selected in chronological order. As another example, all request message log entries of a designated type may be selected for replaying.

At 912, a request message is created based on the selected input message log entry. According to various embodiments, creating the request message may involve various operations. For example, the message body data stored in the server log in an encoded format may be decoded according to the encoding technique specified in the server logging module configuration information retrieved at operation 906. As another example, the message headers may be parsed to remove the separation characters used to separate the message headers in the server log. As yet another example, the message headers and the message body may be combined with each other and/or with other information to recreate the original message.

At 914, the request message is transmitted for analysis. According to various embodiments, the request message may be transmitted to a server and/or to another network destination. Transmitting the request message may involve sending the request message over a network, storing the request message in a storage location where it can be read by the server, or via any other transmission technique.

At 916, a response message created in response to the request message is received. According to various embodiments, the response message may be any type of response message capable of being generated by the server or by a computing device in communication with the server. By analyzing the response message, the method 900 may be used to determine whether the server's response matches the response recorded in the identified server log.

At 918, a response message log entry corresponding to the received response message is identified. According to various embodiments, the response message log entry may be identified in various ways. For example, both messages may have an identifier that corresponds to the request message in response to which the two response messages were created.

At 920, the received response message is compared with the response message log entry. According to various embodiments, comparing the log entry and the message may involve comparing each of the message headers and the message bodies, if the logged message bodies and headers match those of the received response message, then the message is deemed to match. Otherwise, a discrepancy is detected. When a discrepancy is detected, the discrepancy may be noted. Related information such as the particular message header or the portion of the message body that gave rise to the discrepancy may be noted as well.

According to various embodiments, comparing the received, response message with the response message log entry may involve comparing only a static portion of a message. For example, a test server may generate a message that has the same form as a message generated by a production server, but the two messages may differ in content because the two servers may be using different data to construct the messages.

At 922, a determination is made as to whether to replay additional messages. According to various embodiments, additional messages may be replayed until a designated number of simulated messages have been created, until all messages in the identified server log have been replayed, until a designated period of time has passed, until an error condition has been detected, or until some other triggering event has occurred.

According to various embodiments, not all of the operations shown in FIG. 9 need be performed. For example, the server log replay method may be used to present simulated client request messages to a server without being used to test responses generated by the server. In this case, operations 916-920 may be omitted.

In the foregoing specification, the invention has been described with reference to specific embodiments. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of invention.

1. A method comprising:
receiving a plurality of client request messages from one or more client machines at a server logging module in a server;
parsing the received client request messages to extract one or more request headers and an request body from each received client request message;
creating request body characterization information based on the parsed request body; and
storing message information in a server log in accordance with a standard log format, the message information comprising the one or more request headers and the request body characterization information associated with each received client request message.

2. The method recited in claim 1, the method further comprising:
receiving a plurality of server response messages at the server logging module, the server response messages being generated in response to the plurality of client request messages;
parsing the received server response messages to extract one or more response headers and a response body from each received server response message;
creating response body characterization information based on the parsed response body; and
storing the one or more response headers and the response body characterization information associated with each received server response message in the server log in accordance with the standard log format.

3. The method recited in claim 1, the method further comprising:
creating one or more simulated client request messages based on the stored message information, each of the one or more simulated client request messages corresponding to one of the plurality of received client request messages.

4. The method recited in claim 1, wherein creating the request body characterization information comprises encoding the request body in accordance with a data encoding technique.

5. The method recited in claim 1, the method further comprising:
identifying a body size limit based on configuration information; and
determining whether the request body exceeds the body size limit, wherein the request body characterization information comprises a size in memory of the request body when the request body exceeds the body size limit.

6. The method recited in claim 1, wherein the one or more request headers include at least two request headers, and wherein the request headers are separated in the server log by a separation marker.

7. The method recited in claim 1, wherein the storing of the message information in the server log results in an increase in server processing time of no more than one percent.

8. The method recited in claim 1, wherein the one or more request headers comprise all of the request headers associated with each received response message.

9. The method recited in claim 1, wherein the server logging module communicates with the server via a native application programming interface (API) associated with the server.

10. The method recited in claim 1, wherein the server logging module is integrated with the server's core code base.

11. A system comprising:
persistent memory operable to store a server log;
a network interface operable to receive a plurality of client request messages from one or more client machines;
a processor operable to:
parse the received client request messages to extract one or more request headers and an request body from each received client request message;
create request body characterization information based on the parsed request body; and
store message information in the server log in accordance with a standard log format, the message information comprising the one or more request headers and the request body characterization information associated with each received client request message.

12. The system recited in claim 11,
wherein the network interface is further operable to receive a plurality of server response messages, the server response messages being generated in response to the plurality of client request messages, and
wherein the processor is further operable to:
parse the received server response messages to extract one or more response headers and a response body from each received server response message,
create response body characterization information based on the parsed response body, and
store the one or more response headers and the response body characterization information associated with each received server response message in the server log in accordance with the standard log format.

13. The system recited in claim 11, the processor being further operable to:
create one or more simulated client request messages based on the stored message information, each of the one or more simulated client request messages corresponding to one of the plurality of received client request messages.

14. The system recited in claim 11, wherein creating the request body characterization information comprises encoding the request body in accordance with a data encoding technique.

15. The system recited in claim 11, the processor being further operable to:
identify a body size limit based on configuration information; and
determine whether the request body exceeds the body size limit, wherein the request body characterization information comprises a size in memory of the request body when the request body exceeds the body size limit.

16. The system recited in claim 11, wherein the one or more request headers include at least two request headers, and wherein the request headers are separated in the server log by a separation marker.

17. The system recited in claim 11, wherein the storing of the message information in the server log results in an increase in processor processing time of no more than one percent.

18. One or more computer readable media having instructions stored thereon for performing a method, the method comprising:
receiving a plurality of client request messages from one or more client machines at a server logging module in a server;
parsing the received client request messages to extract one or more request headers and an request body from each received client request message;
creating request body characterization information based on the parsed request body; and
storing message information in a server log in accordance with a standard log format, the message information comprising the one or more request headers and the request body characterization information associated with each received client request message.

19. The one or more computer readable media recited in claim 18, the method further comprising:
receiving a plurality of server response messages at the server logging module, the server response messages being generated in response to the plurality of client request messages;
parsing the received server response messages to extract one or more response headers and a response body from each received server response message;
creating response body characterization information based on the parsed response body; and
storing the one or more response headers and the response body characterization information associated with each received server response message in the server log in accordance with the standard log format.

20. The one or more computer readable media recited in claim 18, the method further comprising:
creating one or more simulated client request messages based on the stored message information, each of the one or more simulated client request messages corresponding to one of the plurality of received client request messages.
